(19) United States
(12) Patent Application Publication
(10) Pub. No.: US 2026/0000207 A1
(43) Pub. Date: Jan. 1, 2026

(54) SEAT INSERT AND METHOD OF IMPROVING POSTURE OF A SEATED SUBJECT

(71) Applicant: Sacral Solutions Inc., Creston (CA)

(72) Inventor: Adele HILLS, Creston (CA)

(21) Appl. No.: 19/205,638

(22) Filed: May 12, 2025

Related U.S. Application Data
(63) Continuation of application No. PCT/CA2022/051662, filed on Nov. 10, 2022.

(51) Int. Cl. A47C 7/46; A47C 7/02

(52) U.S. Cl. CPC A47C 7/467; A47C 7/021

(57) ABSTRACT

Described is a seat insert for providing postural support. The seat insert comprises a back portion comprising a support frame, the support frame comprising a plurality of elongate bladders arranged laterally on a front face of the support frame, each bladder hingedly coupled to the front face at an upper portion of each bladder, wherein the plurality of elongate bladders comprise an upper bladder and a lower bladder and wherein a distance between couplings of the lower bladder and the upper bladder is less than the width of the upper bladder, such that the upper bladder overlaps with a portion of the lower bladder. The seat insert may comprise two inflatable side bolsters. Also described is a method of improving posture of a subject when in a seated position on a seat and a kit comprising the seat insert and one or more wedge-shaped seat portions.

### TECHNICAL FIELD

The present disclosure relates to seat inserts and methods of improving posture of a seated subject. In particular, the present disclosure relates to seat inserts for use on existing seats such as vehicle or office seats and to methods of improving the posture of a subject seated in said vehicle or office seat.

### BACKGROUND

Modern vehicle, office and seat designs impose misaligned, over-exaggerated curvatures of the spine that destabilize the natural architecture of the body. Exaggerated curvatures of the spine cause musculoskeletal injury, vertebral compression, loss of spinal disc space, and nerve impingement resulting in back pain.

Bones are the human body's architectural structure designed to hold the body upright and carry the weight of the body, while muscles, joints, and ligaments are mobilizers and stabilizers. When forced out of alignment by improper seat designs, the bones no longer maintain the body weight, forcing muscles and ligaments to strain to hold us upright, leaving them weak and vulnerable to injury.

Support devices related to seated postural correction exist and are shown in U.S. Pat. No. 10,737,599 B2 Yoshikawa et al.; US 2003/0038517 A1, Moran et al.; U.S. Pat. No. 10,791,841 B2, Seo; US 2013/0226053 A1, Khan et al.; U.S. Pat. No. 4,981,325, Zacharkow; US 2007/0001505 A1, Marshall et al.; US 2021/0046856 A1, Franklin; U.S. Pat. No. 7,059,678, Taylor; US 2002/0180249, Felton et al.; and U.S. Pat. No. 11,419,426, Ohanian.

### SUMMARY

The present disclosure relates to a seat insert for improving posture of a seated subject which may be used on existing chairs such as office chairs and vehicle chairs. In at least some aspects of the disclosure, an adjustable seat insert is provided to deliver improved seated postural correction such as spinal alignment to the user thereby avoiding injury associated with incorrect posture.

According to a first aspect, there is provided a seat insert comprising:
a back portion comprising a support frame, the support frame comprising a plurality of elongate bladders arranged laterally on a front face of the support frame, each bladder hingedly coupled to the front face at an upper portion of each bladder,
wherein the plurality of elongate bladders comprise an upper bladder and a lower bladder and wherein a distance between couplings of the lower bladder and the upper bladder is less than the width of the upper bladder, such that the upper bladder overlaps with a portion of the lower bladder.

Inflation or filling of each bladder increases the volume of the bladder and therefore provides pressure (support) to the back of a subject seated on the seat insert. For example, inflation or filling of one or more bladders positioned at a sacral support region will exert pressure on the sacral vertebrae of the user. The seat insert may comprise one or more bladders positioned at a cervical region of the back portion, one or more bladders positioned at a lumbar region, one or more bladders positioned at a thoracic region and/or one or more bladders positioned at a sacral region. Thus, advantageously, in at least some aspects the seat insert provides support to all regions of the spine (cervical, lumbar, thoracic, and sacral/pelvic regions).

Furthermore, inflation of an individual bladder (e.g. the lower bladder) not only provides support for vertebrae adjacent the inflated bladder, but also provides secondary support for vertebrae adjacent the bladder above (the overhanging/upper bladder) as a result of the overlapping arrangement of bladders. The amount of secondary support provided by the overhanging bladder by inflation of the bladder below in turn will depend on the level of inflation of the overhanging bladder. For example, if the overhanging bladder is fully inflated or filled, it will provide more support than if it is fully deflated or empty.

In some aspects, the plurality of bladders may be arranged from a lower portion of the support frame to an upper portion of the support frame. The bladders may cover the full length of the front face of the support frame.

In some aspects, each of the plurality of bladders is oblong. For example, each of the plurality of bladders may be rectangular. In some aspects, each of the plurality of bladders is substantially the same size and/or shape.

In some aspects, the seat insert may comprise two side bolsters located on opposing sides of the support frame. The side bolsters may be solid or semi-solid. For example, the side bolsters may be made of foam. In some aspects, the side bolsters may be inflatable. Advantageously, the side bolsters provide lateral stabilization of the rib cage of the seated subject.

In some aspects, the seat insert further comprises an inflation or filling control system for controlling inflation or filling of each of the plurality of elongate bladders. The inflation or filling of each bladder may be controllable independently. Advantageously, the ability to control the inflation or filling of each bladder independently allows the user to tailor the level of support provided by each bladder to each region of their spine as required.

The inflation control system may control one or more of: the bladder or bladders that are to be inflated, the level of inflation, the speed of inflation, and the direction of air flow e.g. inflation/deflation. In some aspects, the inflation control system comprises an inflation device and a controller. The inflation control system may comprise a manifold for directing air from the inflation device into each the plurality of bladders.

The inflation device may be manually or electronically operated. For example, the inflation device may comprise a manual inflation bulb or may comprise an electronic pump.

The controller may comprise one or more control buttons for selectively directing air into one or more of the plurality of bladders. In some aspects, the controller may be mechanically operated. In some aspects, the controller may comprise an application on a mobile device.

The seat insert may further comprise a seat portion. The seat portion may be separate from the back portion or may be reversibly or permanently coupled to the back portion. The coupling may be a flexible connection such that the seat portion can be folded against the back portion. The seat insert may provide a firm surface to encourage a solid connection and ground force reaction between the subject's sit bones and the seated surface. The seat insert may also provide a surface to align or level the hips. In some aspects, the seat portion may be wedge-shaped. In some aspects, the seat portion may be coupled to the back portion at the apex of the wedge. Advantageously, the wedge-shape seat portion can be used to correct the angle of the seated subject's hips (i.e. the angle between the subject's thighs and torso) to around 90 degrees.

The seat insert may further comprise a protective cover. The seat insert may further comprise a cushion layer to cover the plurality of bladders on the front face of the support frame (e.g. under the protective cover).

In some aspects, the seat insert may be portable. The seat insert may comprise an attachment mechanism for reversibly attaching the seat insert to a seat, which may comprise one or more straps. The seat insert may include carry straps for easy transportation. The attachment mechanism and/or carry straps allow the user the ability to transfer the seat insert from one seat to another to achieve proper spinal alignment whenever required to sit.

According to another aspect, there is provided a seat insert comprising:
a back portion comprising a support frame, the support frame comprising a plurality of elongate bladders arranged laterally on a front face of the support frame, each bladder hingedly coupled to the front face at an upper portion of each bladder, and
two inflatable side bolsters located on opposing sides of the support frame,
wherein the plurality of elongate bladders comprise an upper bladder and a lower bladder and wherein a distance between couplings of the lower bladder and the upper bladder is less than the width of the upper bladder, such that the upper bladder overlaps with a portion of the lower bladder.

According to another aspect, there is provided a method of improving posture (or improving spinal alignment) of a subject when in a seated position on a seat, the method comprising:
aligning the sit bones of the subject on a seat portion such that the subject's thighs are at substantially 90 degrees relative to the subject's torso and such that a majority of the subject's weight is being put through their sit bones;
inflating at least one sacral support bladder on a back portion of the seat to apply pressure to the subject's sacral vertebrae;
inflating at least one lumbar support bladder on the back portion of the seat to apply pressure to the subject's lumbar vertebrae;
inflating at least one thoracic support bladder on the back portion of the seat to apply pressure to the subject's thoracic vertebrae;
inflating at least one cervical support bladder on the back portion of the seat to apply pressure to the subject's cervical vertebrae,
wherein inflation of the at least one sacral, lumbar or thoracic support bladders applies an upward force against the at least one lumbar, thoracic or cervical support bladder, respectively, thereby applying pressure to the subject's lumbar, thoracic or cervical vertebrae, respectively.

In some aspects, the at least one lumbar support bladder is inflated after the at least one sacral support bladder is inflated. In some aspects, the at least one thoracic support bladder is inflated after the at least one lumbar support bladder is inflated. In some aspects, the at least one cervical support bladder is inflated after the at least one thoracic support bladder is inflated.

Advantageously, the seat inserts and methods of at least some aspects allow for concurrent leveling of the hips, and stabilization of the sacrum, ribcage, and entirety of the spine. To properly support the spine while seated, first the hips and pelvis should be level, and the sit bones should be against a firm surface for ground force reaction. This creates a stable base for the spinal vertebrae to stack while aligned. The spine can then be supported from the sacral region to the cervical region of the spine, to keep the vertebrae aligned without engaging surrounding stabilizing muscles and ligaments.

According to another aspect, there is provided a kit comprising a seat insert (or a back portion) as described herein and one or more wedge-shaped seat portions. In some aspects, an apex of the wedge-shaped seat portion is configured to be positioned adjacent a bottom or lower edge of the back portion of the seat insert. In some aspects, an apex of the wedge-shaped seat portion is attached to a bottom or lower end of the back portion of the seat insert. It may be desired to provide the seat insert having a back portion with a range of different seat portions with wedges at various angles such that the user can select the appropriate amount of hip levelling for a given seat.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows a perspective view of seat insert in accordance with a first embodiment, without a protective cover;

FIG. 2 shows an exploded view of the seat insert of FIG. 1;

FIG. 3 shows an exploded view of a sub-assembly of the back portion of the seat insert of FIG. 1;

FIG. 4 shows a front view of the seat insert of FIG. 1, except with an electronic controller rather than a manual controller;

FIG. 5 shows a side view of the seat insert of FIG. 1;

FIG. 6 shows a perspective view of a sub-assembly of the back portion of a seat insert in accordance with a second embodiment;

FIG. 7 shows an exploded view of the back portion of the seat insert of FIG. 6;

FIG. 8 shows a seat insert in accordance with a third embodiment (without side bolsters) in position on a vehicle seat;

FIG. 9 shows a back view of the seat insert of FIG. 8 in an extended configuration;

FIG. 10 shows a manual inflation bulb as used in the embodiment shown in FIG. 1; and

FIG. 11 shows an electronic controller as used in the embodiment shown in FIG. 4.

### DETAILED DESCRIPTION

The seat insert disclosed herein comprises a back portion comprising a support frame. The support frame comprises a plurality of elongate bladders arranged laterally on a front face of the support frame. The elongate bladders are arranged to support the vertebrae of a user of the seat insert. Each bladder is hingedly coupled to the front face at an upper portion of each bladder. A distance between couplings of a lower bladder and an upper bladder is less than the width of the upper bladder, such that the upper bladder overlaps with a portion of the lower bladder. In embodiments comprising more than two bladders, the distance between couplings of each pair of bladders may be similarly configured such that each upper bladder overlaps with a portion of each lower bladder. For example, each bladder may either overhang and/or be overhung by, an adjacent bladder.

The seat insert may be for improving posture of a seated subject. The plurality of elongate bladders may be arranged from a sacral support region to a cervical support region of the support frame. The plurality of bladders may be arranged laterally between opposing sides of a front face of the support frame. The bladders may be provided in an inflated configuration or a deflated configuration. In some embodiments, the upper bladder may only overlap with the lower bladder when the upper bladder or the lower bladder or both are in the inflated configuration.

When each bladder is inflated or filled, the bladder increases in volume thereby applying pressure (support) to the subject's vertebrae that are in contact with/adjacent to the bladder. Due to the overlapping configuration of the bladders, the expansion of volume of a lower bladder may support or exert pressure on the bladder above. For example, the pressure applied by the inflated lower bladder may cause the overhanging (upper) bladder to hinge towards an upper edge of the support frame. This in turn may provide support to the subject's vertebrae that are in contact with/adjacent to the overhanging (upper) bladder.

The seat insert may further comprise an inflation or filling control system for controlling inflation or filling of each of the plurality of elongate bladders. The inflation or filling of each bladder may be controlled independently.

Also described herein is a seat insert further comprising two inflatable or fillable side bolsters located on opposing sides of the support frame. The inflation or filling control system may be for controlling inflation or filling of each of the plurality of elongate bladders and the inflatable side bolsters independently.

Also described herein is method of improving posture (or spinal alignment) of a subject when in a seated position on a seat. The method comprises (i) aligning the sit bones of a subject on a seat portion such that the subject's thighs are at substantially 90 degrees relative to the subject's torso and such that a majority of the subject's weight is being put through their sit bones; (ii) inflating at least one sacral support bladder on a back portion of the seat to apply pressure to the subject's sacral vertebrae; (iii) inflating at least one lumbar support bladder on the back portion of the seat to apply pressure to the subject's lumbar vertebrae; (iv) inflating at least one thoracic support bladder on the back portion of the seat to apply pressure to the subject's thoracic vertebrae; (v) inflating at least one cervical support bladder on the back portion of the seat to apply pressure to the subject's cervical vertebrae. When each of the at least one sacral, lumbar or thoracic support bladders are inflated, they exert an upward force against the at least one lumbar, thoracic or cervical support bladder, respectively, which in turn applies pressure to the subject's lumbar, thoracic or cervical vertebrae, respectively. The pressure applied to the subject's vertebrae provides support which reduces stress on surrounding muscles, joints and ligaments and maintains the spine in proper alignment.

The term “bladder” refers to a pocket for holding a gas or other substance. In some aspects, the bladders are inflatable and can be filled with a gas. Alternatively, the bladders may be filled with another substance such as a liquid or gel. Thus, the “inflation control system” is used for bladders that hold a gas and the term “filling control system” refers to aspects in which the bladders hold another substance e.g. a liquid or gel. The terms “inflation control system” and “filling control system” are used interchangeably herein. It will be appreciated that aspects of the invention that describe inflatable bladders and inflation can also be applied to fillable bladders and filling said bladders (e.g. with liquid or gel). In embodiments where the bladders are inflatable, the bladders may be inflated with any suitable gas, however, for the embodiments described herein, the gas is air.

“Plurality of bladders” means more than one bladder, i.e. two or more bladders. In some embodiments, the seat insert comprises at least four bladders. In some embodiments, the seat insert comprises at least five bladders. In some embodiments, the seat insert comprises at least six bladders. The bladders may comprise an inflatable air pocket which may be sealed by a border or alternatively the bladders may be made from a resilient material that stretches when inflated. Alternative suitable bladder constructions are also known.

The “elongate” bladders may comprise an elongated edge that is longer than the bladder's shorter edge. The elongate bladders may be arranged with an elongate edge substantially perpendicular to the opposing side edges of the support frame. The elongate edge may be at the upper portion of each bladder and each bladder may be hingedly coupled to the front face of the support frame at an upper elongate edge.

In some embodiments, each of the elongate bladders may be comprised of two sub bladders arranged along the support frame in two columns. Alternatively, each elongate bladder may comprise two air pockets that may be independently inflatable. Such embodiments may be beneficial for postural correction in subjects with spinal deformities or back injuries where the support and/or postural correction that is required is non-symmetrical with respect to the subject's spine.

The plurality of bladders may be arranged laterally from a sacral region of the support frame to a cervical region of the support frame. The terms “sacral region” and “cervical region” are not intended to be limiting to a particular area of the support frame, but refer to regions of the support frame that would typically be aligned with the subject's sacral vertebrae and cervical vertebrae, respectively, when in a seated position on the seat insert. Similarly, one or more of the plurality of bladders may be termed “sacral region bladders”, one or more of the plurality of bladders may be termed “lumbar region bladders”, one or more of the plurality of bladders may be termed “thoracic region bladders” and one or more of the plurality of bladders may be termed “cervical region bladders”. The sacral region bladder(s) may prevent any rocking of the pelvis, to keep a level base for stacking vertebrae. The lumbar region bladder(s) may aid in stabilizing the lumbar vertebrae and keeping them aligned. The thoracic region bladder(s) may stabilize the thoracic vertebrae and expand the ribcage to improve lung expansion and oxygenation. The cervical region air bladder(s) may aid in stabilizing the cervical vertebrae and keeping them aligned.

It should be noted that identity of the sacral, lumbar, thoracic and/or cervical region bladders may change depending on the length of the subject's spine. For example, for a tall subject whose back is substantially the same length as the support frame, all of the plurality of bladders could be inflated to provide support to each of the user's spinal regions. On the other hand, for a shorter user whose back is shorter in length than the height of the support frame, the bladders located near the top of the support frame may be redundant and therefore the user may only need to inflate the lower bladders to provide support to each of the user's spinal regions. Thus, it will be appreciated that the length or height of the support frame will be a suitable height to accommodate a tall user. The definition of ‘tall’ may vary depending on the country and/or geographical location in which the seat insert is used but typically the length of the back of an adult human from sacrum to cervix will be between 60 to 140 cm.

In at least some of the embodiments described herein, the level of inflation, speed of inflation and direction of airflow to each of the plurality of bladders is individually adjustable e.g. by the user, and is controlled using the inflation control system.

The inflation control system may comprise an inflation device for directing air into the plurality of bladders. The inflation device may be operated manually or electronically, or a combination of both. In some embodiments, the inflation device may comprise a manual inflation device such as an inflation bulb. In other embodiments, the inflation device may comprise an electronic inflation device such as an electric pump. In other embodiments, the inflation device may comprise both manual and electronic components. The electronic inflation device may be powered by a battery or by mains electricity.

The inflation device may be connected to an inlet of each of the bladders using tubes or hoses. The tubes or hoses may be joined using a manifold.

The inflation control system may further comprise a controller for controlling the distribution of air from the inflation device. For example, the user may wish to add air to a sacral region bladder(s) to adjust the level of support (e.g. to make the sacral region of the seat insert firmer) and accordingly may select on the controller to direct air from the inflation device to the sacral region bladder(s). In some embodiments, the controller may be manually operated such as one or more physical buttons. In other embodiments, the controller may be electronically operated such as one or more electronic buttons. The controller may comprise a device attached or removably attached to the seat insert or an externally located device. For example, a controller may comprise a microcontroller located on the seat insert and an application on a mobile device to communicate wirelessly with the microcontroller. The controller may have the ability to save one or more preset configurations so that the user can automatically set the desired inflation levels of each bladder depending on the type of seat that the seat insert is being used on. The controller may comprise, for example, valving that selectively directs air to any one or more of the bladders in response to the button presses. Alternatively, in embodiments in which the controller is electronic, the controller may comprise a processing unit that similarly responds to button presses. In at least some embodiments the processing unit may be controlled by a mobile device, thereby allowing the mobile device to control inflation of any one or more of the bladders or various subsets thereof (e.g., just the bladders that provide support to the sacral region, and/or just the bladders that provide support to the lumbar region). The controller may further comprise wireless communication circuitry such as a chipset that enables Bluetooth™ communication to permit wireless communication with the mobile device.

In some embodiments, the seat insert comprises two side bolsters located on opposing sides of the support frame. The side bolsters may be included to stabilize the ribcage laterally and may be shaped to contour the ribcage of a user. In the embodiments described herein, the side bolsters are generally located at the thoracic region of the support frame and may be any suitable size and shape. In some embodiments, the side bolsters may also extend along opposing sides of the support frame to any of the sacral, lumbar, thoracic and/or cervical regions.

The side bolsters may be made of foam or any other suitable material. In certain embodiments, the side bolsters may comprise inflatable side bladders. The inflation of each side bladder may be controlled independently of each other and independently of the plurality of bladders positioned to be adjacent the spine. The inflation of the side bolsters may be controlled using the inflation control system.

The seat insert may further comprise a seat portion. The seat portion and back portion may be coupled or connected through any suitable means. For example, the seat portion and back portion may be coupled via a protective cover as described below, or alternatively may be coupled with fasteners. In some embodiments, the seat portion and back portion are pivotally coupled. This flexible coupling means that the angle between the seat portion and back portion can be readily adjusted to accommodate any seat that it is placed on. The ability for the seat insert to be folded, e.g. by folding the seat portion towards the back portion, assists the user to transport the seat insert. The coupling between the seat portion and the back portion may be permanent or alternatively may be temporary such that the user can replace the seat portion with alternative seat portions.

The seat portion may be any suitable shape or material suitable for a user to sit on. In some embodiments, the seat portion may be made of foam. For example, the foam should be suitably firm or rigid to provide a surface for ground force reaction between the sit bones of the user and the seated surface whilst having the ability to conform to the shape of the user's buttocks and to absorb vibrations.

In some embodiments, the seat portion is a wedge-shape, with the apex of the wedge at the edge nearest the bottom of the back portion. One advantage of using a wedge-shaped seat portion is to bring the angle of the user's hips to 90 degrees (i.e., the angle between the user's torso and thighs) for correct postural positioning. This is to ensure the user is putting their weight properly on their sit bones. When the user puts their weight on their sit bones this causes the vertebrae in the spine to properly stack. The user will then typically reposition the flesh of their backside to ensure their sit bones are in contact with the firm surface of the seat portion. This helps stabilize the pelvis.

The height of the wedge will therefore depend on the seat on which the seat insert is intended to be used, for example, vehicle seats are typically slope backwards and therefore a wedge will typically be required to achieve hip levelling. For example, the wedge may be 1.0″ high or 1.5″ high. The seat insert may also be provided with seat portion wedges of varying sizes so that the user can select the appropriate size wedge based on the seat or chair that they will be using.

It will be appreciated that in certain embodiments the seat portion may not be required to achieve levelling of the user's hips, for example, when the seat already provides a suitable surface for the sit bones and the subject's hips are already bent at a 90 degree angle between the torso and the thigh, with the pelvis in the upright position by the seat or chair. In such cases, the back portion may be used independently.

The combination of the overlapping bladders on the back portion, the side bolsters and appropriate hip levelling (e.g. by the seat portion) together provide full support to the spine of the user. However, some embodiments of the seat insert may not require side bolsters for example, if stabilization of the ribcage is already provided by the seat on which the seat insert is to be used. Thus, at least some embodiments also provide a seat insert for use on a seat or chair that comprises side bolsters.

The seat insert may comprise a removable cover e.g. an upholstery cover. The cover may have adjustable straps for removably attaching the seat insert to the desired vehicle or office seat, making it easy to install, remove and transport. For example, the straps may comprise hook-and-loop fasteners (e.g., Velcro™ fasteners) or buckles. The adjustable straps may be of any appropriate length to attach the seat insert to a variety of seats. The cover may also connect the seat portion to the back portion e.g. sewn on fasteners.

The following contains a description of certain example embodiments.

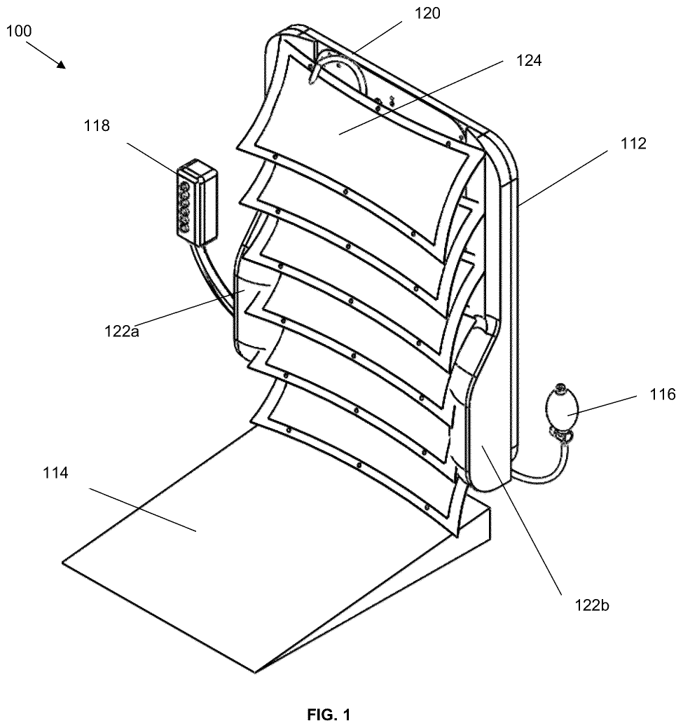

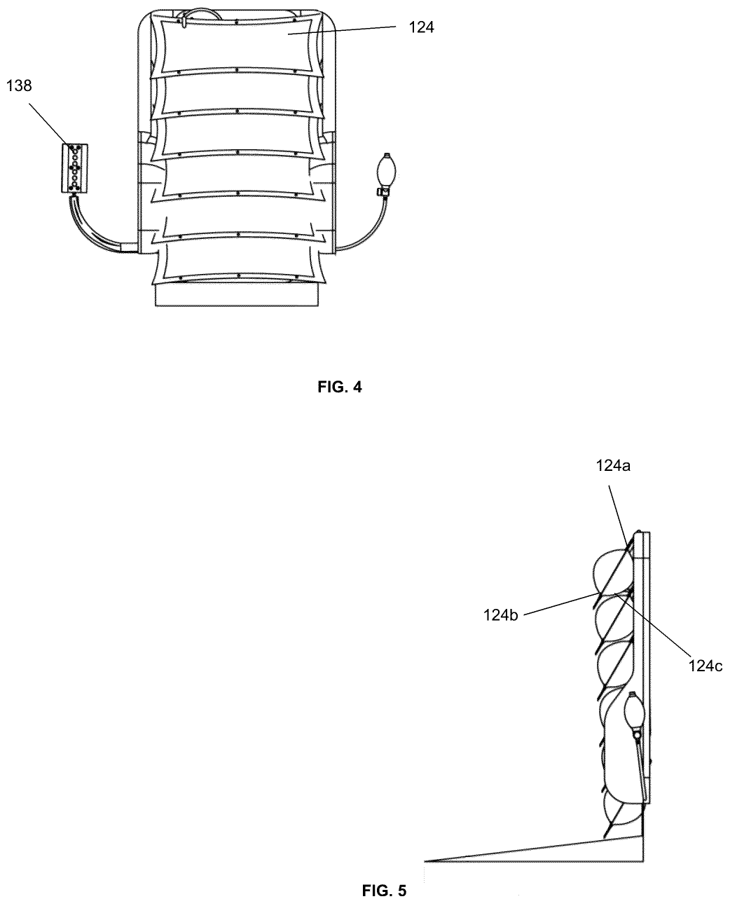

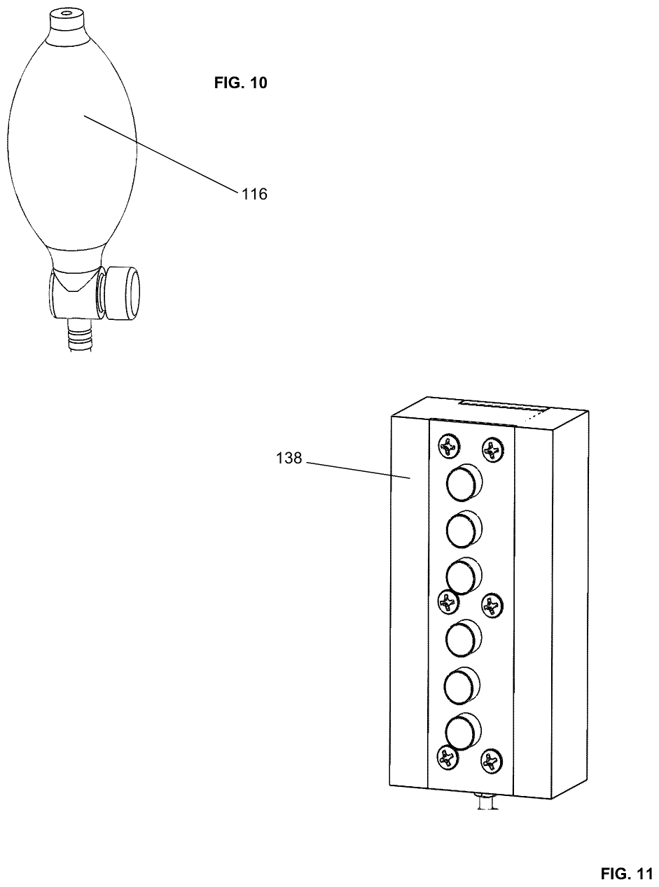

An embodiment of a seat insert 100 is shown in FIG. 1. The seat insert 100 comprises a back portion 112, a wedge-shaped seat portion 114 and a manually operated pneumatic control system comprising an inflation bulb 116 (shown in detail in FIG. 10) and controller 118. FIG. 4 shows an equivalent seat insert except with an electronic controller 138 (shown in detail in FIG. 11).

As illustrated in FIG. 3, the back portion 112 comprises a support frame 120 and two side bolsters 122a, 122b positioned symmetrically on either side of the support frame 120. The support frame 120 is made up of a foam frame 120a which is adhesively attached to a plastic frame 120b.

The back portion 112 comprises six air bladders 124 which are fastened to the support frame 120 through both the plastic frame 120b and the foam frame 120a. The bladders 124 are rectangular in shape and are made of two pieces of material stitched together along a border of the rectangle to form a central air pocket and an inlet for accessing the central air pocket.

Each bladder 124 comprises a hose connected to its inlet and each hose is connected to a manifold (not shown) which is in turn connected to the inflation bulb 116. The manifold is operated by the controller 118 which allows the user to select which bladder (or bladders) will be inflated through operation of the inflation bulb 116. The inflation bulb 116 also comprises a relief valve (not shown) to allow air to flow out of the bladder(s) that is selected through the manifold.

As illustrated best in FIG. 5, each of the six air bladders is fastened to the support frame 120 from an upper part of the bladder (e.g. an upper border) 124a, such that the lower part of each bladder 124b hangs downwardly with the upper part acting as a hinge. Each bladder is fastened using three zip ties fed through three respective holes on the upper perimeter of each bladder which are fed into respective holes on the support frame 120. Alternative fastening mechanisms could also be used e.g. screws, nails, bolts, anchors, rivets, tape or adhesive (embodiments not shown).

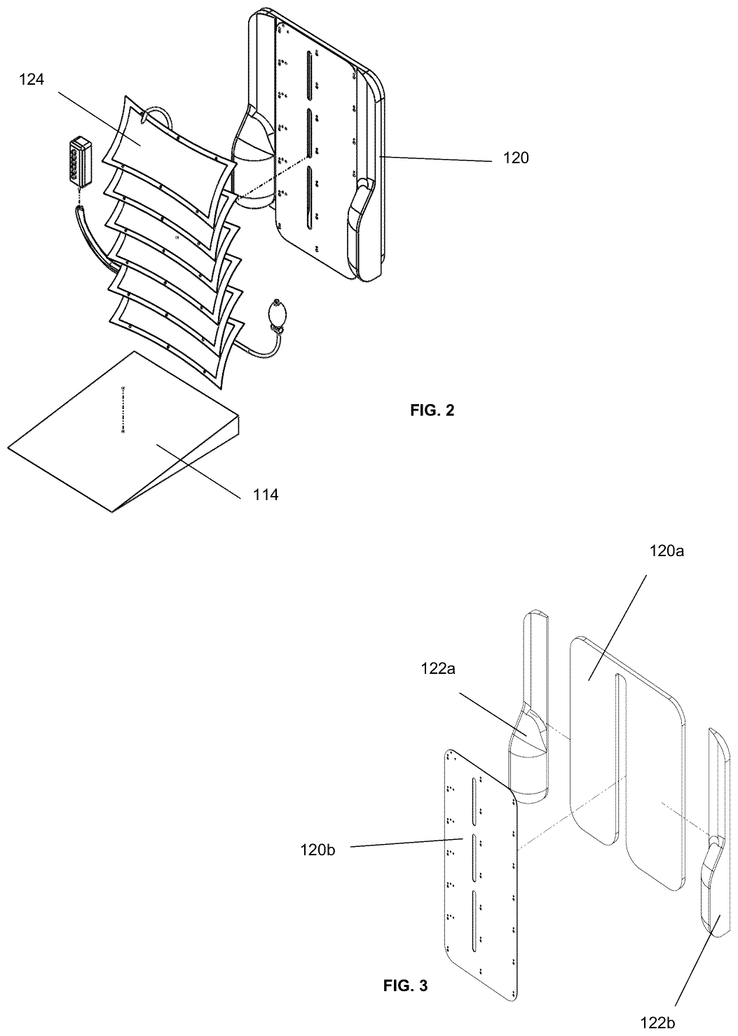

Each bladder 124 is fastened to the support frame at a distance that is less than the width of each bladder, such that a region of overlap 124c is created with an adjacent bladder. For example, as can be seen from FIGS. 1, 2, 4 and 5, each bladder 124 overlaps with the bladder directly below (except for the lowermost bladder which does not have a bladder below it). When an individual bladder is inflated, the increase in volume causes the bladder above to hinge about the fastening on the upper part 124a such that the lower part 124b moves upwardly and away from the support frame (i.e. pivots about the hinge). Thus, inflation of an individual bladder not only provides support for vertebrae adjacent the inflated bladder, but also provides secondary support for vertebrae adjacent the bladder above. The amount of secondary support provided to the bladder above by inflation of the bladder below in turn will depend on the level of inflation of the bladder above.

In use, it is expected that the user will first position their sit bones on the seat portion (if present) or the seat such that their weight is on their sit bones, also ensuring that their hips are at 90 degrees. The user will then position their ribcage between the side bolsters (if present) to prevent lateral movement of the ribcage. The user will then inflate the lowermost bladder (or bladders)—e.g. the sacral bladder(s)—until they feel firm pressure on their sacral bones. Some users may feel this as pressure against their hips. The purpose of the lowermost air bladder(s) is to support the pelvic/sacral region. Once firm support is felt at the pelvic sacral region, the user is to then inflate the next bladder(s)—e.g. the lumbar bladder(s)—until they feel support at their lumbar region. The rest of the bladders would then be filled until the user is sitting upright comfortably and feeling support from each bladder. The purpose of the upper air bladders are to lift the chest and thoracic region to ensure stacked vertebrae.

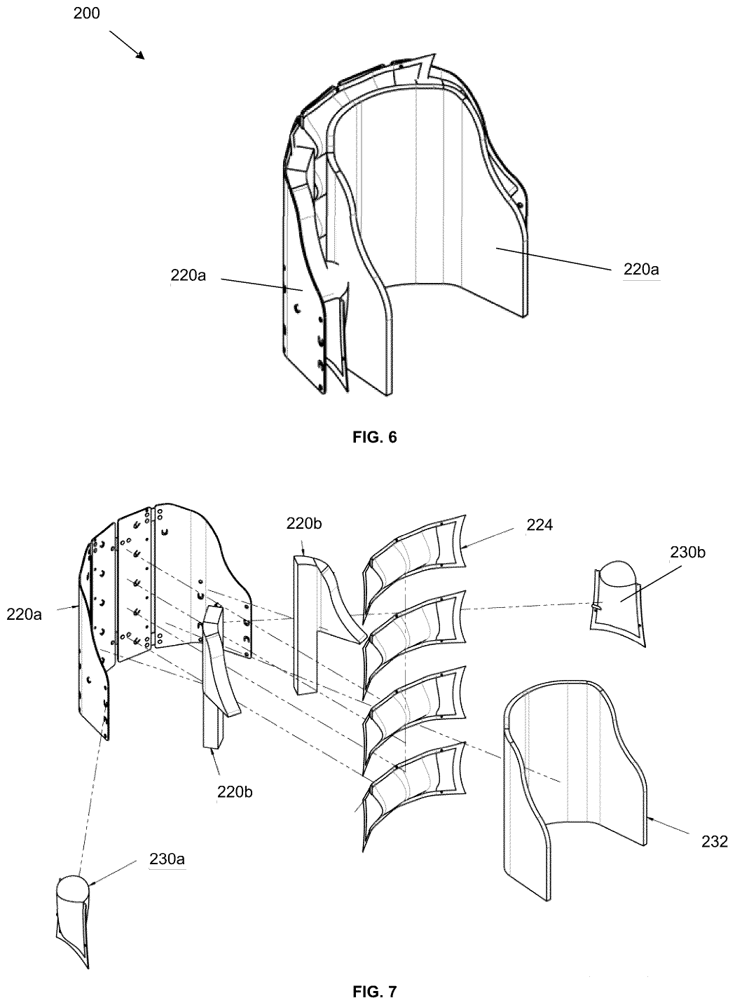

FIGS. 6 and 7 show an alternative embodiment of a seat insert 200 similar to the seat insert 100 except having four bladders 224 and having inflatable side bolsters 230a, 230b. The support structure 220 is composed of a plastic portion 220a and two foam inserts 220b and has a curved profile.

The bladders 224 are constructed similarly to bladders 124 except that the air pocket is shorter in width. The bladders 224 are fastened to the plastic portion of the support structure 220a and the foam inserts 220b are fastened symmetrically on either side of the plastic portion.

Although not shown in FIG. 7, the bladders 224 are fastened to the support frame 220 similarly to seat insert 100—hinging from an upper part of the bladder (e.g. an upper border), such that the lower part of each bladder hangs downwardly, and at a distance that is less than the width of each bladder, such that a region of overlap is created with an adjacent bladder.

Inflatable side bolsters 230a, 230b are fastened to the foam inserts 220b symmetrically on either side of the support structure 220. In addition, the embodiment in FIGS. 6 and 7 comprises a flexible back cushion 232 covering the bladders 224.

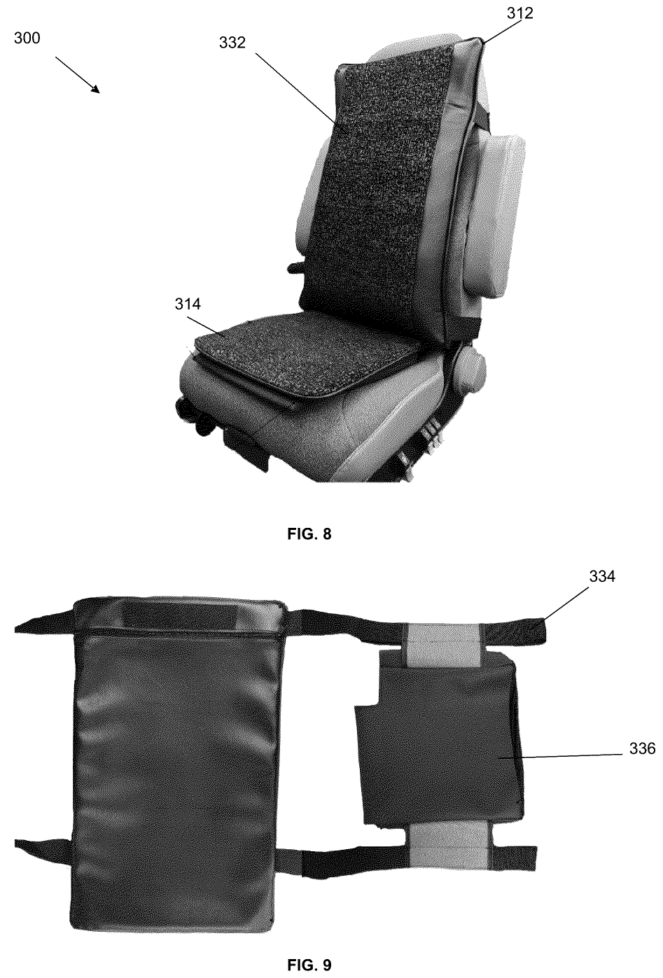

FIGS. 8 and 9 show an alternative embodiment of a seat insert 300 having a back portion 312 and a seat portion 314 in position on a vehicle seat. The seat insert 300 is similar to seat inserts 100 and 200 except that it does not have side bolsters The seat insert 300 has a protective cover 332 made of vinyl and tweed. Hook-and-loop straps 334 are used to secure the seat insert 300 in position on the vehicle seat.

The embodiment in FIGS. 8 and 9 comprises a battery operated electronic inflation control system and the components are contained in a pocket 336, which is attached to the seat insert via the straps 334. In use, the electronic inflation control system is positioned on the rear side of the vehicle seat.

The seat insert may further comprise a neck support (not shown). It is expected that drivers who use the seat insert on vehicle seats may require additional neck support to account for the width of the seat insert.

It is contemplated that any part of any aspect or embodiment discussed in this specification can be implemented or combined with any part of any other aspect or embodiment discussed in this specification, unless those parts are mutually exclusive.

The “controller” herein may comprise any suitable processing unit such as a processor, microprocessor, programmable logic controller, a microcontroller (which comprises both a processing unit and a non-transitory computer readable medium), or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like.

As used herein, the terms “comprising,” “having,” “including” and “containing,” and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method or use functions. The term “consisting of” when used herein in connection with a composition, use or method, excludes the presence of additional elements and/or method steps.

As used herein, the term “about”, when used to describe a recited value, means within 10% of the recited value. It is to be understood that such a variation is always included in any given value provided herein, whether or not it is specifically referred to.

All citations are hereby incorporated by reference.

One or more embodiments are described above. However, it will be apparent to persons skilled in the art that a number of variations and modifications can be made without departing from the scope of the invention as defined in the claims. The scope of the claims should not be limited by the embodiments set forth in the examples, but should be given the broadest interpretation consistent with the description as a whole.

1. A seat insert comprising:
a back portion comprising a support frame, the support frame comprising a plurality of elongate bladders arranged laterally on a front face of the support frame, each bladder hingedly coupled to the front face at an upper portion of each bladder,
wherein the plurality of elongate bladders comprise an upper bladder and a lower bladder and wherein a distance between couplings of the lower bladder and the upper bladder is less than the width of the upper bladder, such that the upper bladder overlaps with a portion of the lower bladder.

2. The seat insert of claim 1, wherein the plurality of bladders are arranged from a lower portion of the support frame to an upper portion of the support frame.

3. The seat insert of claim 1, wherein each of the plurality of bladders is oblong.

4. The seat insert of claim 1, wherein each of the plurality of bladders is rectangular.

5. The seat insert of claim 1, wherein each of the plurality of bladders is substantially the same size.

6. The seat insert of claim 1, further comprising two side bolsters located on opposing sides of the support frame.

7. The seat insert of claim 6, wherein the side bolsters are solid or semi-solid.

8. The seat insert of claim 6, wherein the side bolsters are inflatable.

9. The seat insert of claim 1, further comprising an inflation control system for controlling inflation of each of the plurality of elongate bladders.

10. The seat insert of claim 9, wherein inflation of each bladder is controlled independently.

11. The seat insert of claim 9 wherein the inflation control system comprises an inflation device and a controller.

12. The seat insert of claim 9, wherein the inflation control system comprises a manifold for directing air from the inflation device into each the plurality of bladders.

13. The seat insert of claim 11, wherein the inflation device comprises a manual inflation bulb.

14. The seat insert of claim 11, wherein the inflation device comprises an electronic pump.

15. The seat insert of claim 11, wherein the controller comprises one or more control buttons for selectively directing air into one or more of the plurality of bladders.

16. The seat insert of claim 11, wherein the controller comprises an application on a mobile device.

17. The seat insert of claim 1, further comprising a seat portion.

18. The seat insert of claim 17, wherein the seat portion is wedge-shaped.

19. The seat insert of claim 1, further comprising a protective cover covering the back portion and bladders.

20. The seat insert of claim 1, further comprising an attachment mechanism for reversibly attaching the seat insert to a seat.

21. The seat insert of claim 20, wherein the attachment mechanism comprises one or more straps.

22. The seat insert of claim 1, further comprising a cushion layer to cover the plurality of bladders on the front face of the support frame.

23. A seat insert comprising:
a back portion comprising a support frame, the support frame comprising a plurality of elongate bladders arranged laterally on a front face of the support frame, each bladder hingedly coupled to the front face at an upper portion of each bladder, and
two inflatable side bolsters located on opposing sides of the support frame,
wherein the plurality of elongate bladders comprise an upper bladder and a lower bladder and wherein a distance between couplings of the lower bladder and the upper bladder is less than the width of the upper bladder, such that the upper bladder overlaps with a portion of the lower bladder.

24. A method of improving posture of a subject when in a seated position on a seat, the method comprising:
aligning the sit bones of the subject on a seat portion such that the subject's thighs are at substantially 90 degrees relative to the subject's torso and such that a majority of the subject's weight is being put through their sit bones;
inflating at least one sacral support bladder on a back portion of the seat to apply pressure to the subject's sacral vertebrae;
inflating at least one lumbar support bladder on the back portion of the seat to apply pressure to the subject's lumbar vertebrae;
inflating at least one thoracic support bladder on the back portion of the seat to apply pressure to the subject's thoracic vertebrae;
inflating at least one cervical support bladder on the back portion of the seat to apply pressure to the subject's cervical vertebrae,
wherein inflation of the at least one sacral, lumbar or thoracic support bladders applies an upward force against the at least one lumbar, thoracic or cervical support bladder, respectively, thereby applying pressure to the subject's lumbar, thoracic or cervical vertebrae, respectively.

25. The method of claim 24, wherein the at least one lumbar support bladder is inflated after the at least one sacral support bladder is inflated.

26. A kit comprising:
the seat insert according to claim 1; and
one or more wedge-shaped seat portions wherein an apex of the wedge-shaped seat portion is configured to be positioned adjacent a bottom of the back portion of the seat insert.
